(19) United States
(12) Patent Application Publication
(10) Pub. No.: US 2024/0271946 A1
(43) Pub. Date: Aug. 15, 2024

(54) CLIMB PREDICTION SYSTEM

(71) Applicant: Garmin International, Inc., Olathe, KS (US)

(72) Inventors: Logan W. J. Wilson, Overland Park, KS (US); Jashwant B. Patel, Overland Park, KS (US); Austin D. Hartman, Olathe, KS (US); Jordan A. Miller, Olathe, KS (US); Pascal M. Lutz, Stilwell, KS (US)

(21) Appl. No.: 18/168,231

(22) Filed: Feb. 13, 2023

(51) Int. Cl. G01C 21/34; G01C 21/36

(52) U.S. Cl. CPC G01C 21/3415; G01C 21/362; G01C 21/367; G01C 21/3697

(57) ABSTRACT

A portable electronic device configured to be used by a user riding a bicycle. The portable electronic device stores cartography data and climb data, and includes a location-determining element. The portable electronic device further includes a graphic display. Furthermore, the portable electronic device is configured to (i) determine, via the location-determining element, a location of the portable electronic device, (ii) determine, based on the location of the portable electronic device and the cartography data and/or the climb data, a predicted route along which the user is predicted to ride the bicycle, (iii) present, via the graphic display, information indicative of the predicted route, (iv) determine, based on the cartography data and/or the climb data, one or more optional routes located adjacent to the predicted route along which the user can optionally ride the bicycle, and (v) present, via the graphic display, climb data associated with the optional routes.

### Field

Embodiments of the present invention are directed to a climb prediction system. More particularly, embodiments of the present invention are directed to a system configured to be mounted to a bicycle and configured to provide a user with predictive information related to routes over which the user is travelling or may travel during a cycling event.

### DESCRIPTION OF RELATED ART

Cycling has become a popular exercise and entertainment activity. One particularly popular aspect of cycling is hill climbing. A hill climb commonly refers to a portion of a cycling event in which altitude is gained over the route the rider is traveling. As such, hill climbs will generally start at a lower altitude and terminate at a summit, which is at a higher altitude. There currently exists various systems for presenting to a user the user's progress through one or more hill climbs. However, such systems generally require the user to pre-plan the user's route before the user begins a cycling event or fail to account for different route options while cycling.

### SUMMARY

Embodiments of the present invention comprise a portable electronic device configured to be used by a user riding a bicycle. The portable electronic device comprises one or more memory elements, with the memory elements being configured to store cartography data and climb data. The portable electronic device additionally includes a location-determining element configured to determine a location of the portable electronic device. The portable electronic device further includes a graphic display configured to present the cartography data and/or the climb data in a graphical format. Furthermore, the portable electronic device is configured to perform a number of steps. One step includes determining, via the location-determining element, a location of the portable electronic device. An additional step includes determining, based on the location of the portable electronic device and the cartography data and/or the climb data, a predicted route along which the user is predicted to ride the bicycle. An additional step includes presenting, via the graphic display, information indicative of the predicted route. An additional step includes determining, based on the cartography data and/or the climb data, one or more optional routes located adjacent to the predicted route along which the user can optionally ride the bicycle. A further step includes presenting, via the graphic display, climb data associated with the optional routes.

This summary is not intended to identify essential features of the present invention, and is not intended to be used to limit the scope of the claims. These and other aspects of the present invention are described below in greater detail.

### BRIEF DESCRIPTION OF THE DRAWINGS

Embodiments of the present invention are described in detail below with reference to the attached drawing figures, wherein:

FIG. 1 is a perspective view of a portion of a bicycle with a portable electronic device attached to the bicycle via a connector;

FIG. 2 is a schematic diagram of components of the portable electronic device from FIG. 1;

FIG. 3 is a graphical user interface (GUI) displayable on a graphic display of the portable electronic device from FIGS. 1 and 2, with the GUI illustrating a graphical map with a first route that could potentially be determined by the portable electronic device to be a predicted, primary route;

FIG. 4 is a GUI displayable on a graphic display of the portable electronic device from FIGS. 1 and 2, with the GUI illustrating a graphical map with a second route that could potentially be determined by the portable electronic device to be a predicted, primary route;

FIG. 5 is a GUI displayable on a graphic display of the portable electronic device from FIGS. 1 and 2, with the GUI illustrating a graphical map with a third route that could potentially be determined by the portable electronic device to be a predicted, primary route;

FIG. 6 is a GUI displayable on a graphic display of the portable electronic device from FIGS. 1 and 2, with the GUI illustrating a graphical map with a predicted, primary route and two optional routes;

FIG. 7 is a GUI displayable on a graphic display of the portable electronic device from FIGS. 1 and 2, with the GUI illustrating a split screen with a first portion presenting a graphical map with a predicted, primary route and two optional routes and a second portion presenting climb data associated with the predicted, primary route;

FIG. 8 is a GUI displayable on a graphic display of the portable electronic device from FIGS. 1 and 2, with the GUI illustrating a user changing routes from the predicted, primary route to one of the optional routes;

FIG. 9 is a GUI displayable on a graphic display of the portable electronic device from FIGS. 1 and 2, with the GUI illustrating a split screen with a first portion presenting a graphical map with a predicted, primary route and an optional route and a second portion presenting climb data associated with a previous optional route that has transitioned to the predicted, primary route; and

FIG. 10 is GUI displayable on a graphic display of the portable electronic device from FIGS. 1 and 2, with the GUI illustrating a graphical map of a route having been completed by a user.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Embodiments of the present invention are directed to a climb prediction system that comprises a portable electronic device that can be used by a user riding a bicycle to predict primary and optional routes over which the user is (or may be) travelling with a bicycle during a cycling event. The term “cycling event” is used herein to mean an activity performed by a user riding on a bicycle for a given amount of time or distance. The cycling event may be a race, a planned course, intentional exercise, or even casual cycling with no planned course, direction, or route. That is, embodiments of the present invention may be utilized during any cycling event, even those that are unplanned and unstructured. The predicted and optional routes may include routes over which the cyclist may ride that specifically contain one or more climbs. Additionally, in some examples, the device can be utilized for other activities beyond, or as an alternative to cycling. For example, instead of a cycling event, the device can be used to predict primary and optional routes for running, trail running, hiking, rock climbing, combinations thereof, and the like.

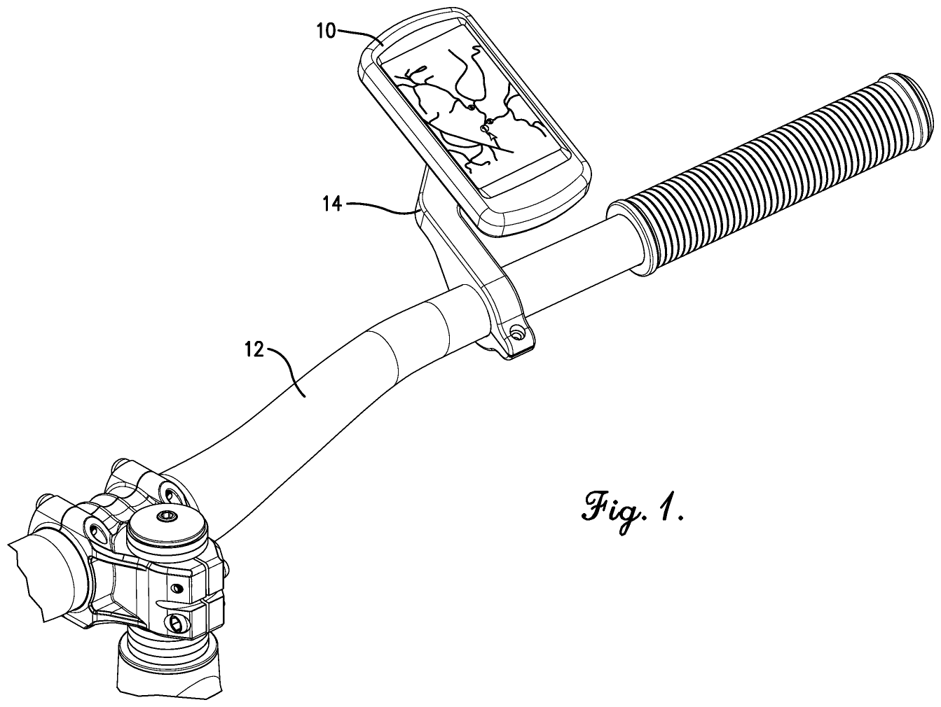

The portable electronic device may be further configured to present to the user information related to such predicted primary and optional routes (e.g., climb data) as the user is performing the cycling event. In more detail, such a portable electronic device is illustrated by reference numeral 10 in FIG. 1, and is configured to be removably coupled with a bicycle 12. Such coupling may be facilitated by a connector 14 that interconnects the device 10 with the bicycle 12.

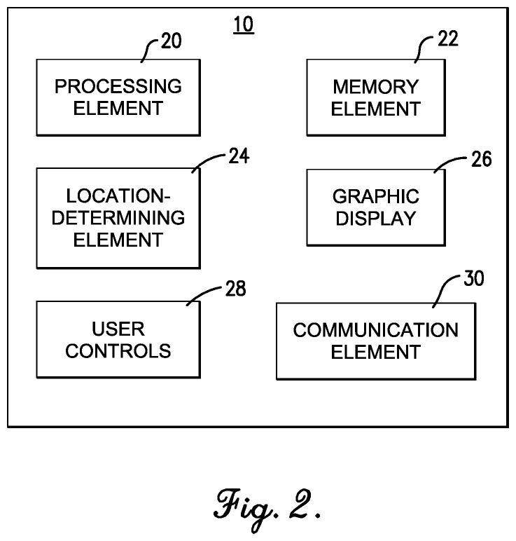

Turning to the device 10 in more detail, as schematically illustrated in FIG. 2, the device 10 may generally comprise a computing device that includes one or more processing elements 20, one or more memory elements 22, one or more location-determining elements 24, a graphic display 26, one or more user controls 28, and/or a communication element 30. The processing element 20 may implement operating systems, and may be capable of executing a computer program (which may be stored on the memory element 22), which is also generally known as instructions, commands, software code, executables, applications (“apps”), and the like. The processing element 20 may include processors, microprocessors, microcontrollers, field programmable gate arrays, and the like, or combinations thereof. The memory element 22 may be capable of storing or retaining the computer program and may also store data, typically binary data, including text, databases, graphics, audio, video, combinations thereof, and the like. The memory element 22 may also be known as a non-transitory “computer-readable storage medium” and may include random access memory (RAM), read only memory (ROM), flash drive memory, floppy disks, hard disk drives, optical storage media, and the like, or combinations thereof. In general, the memory element 22 may be configured to store all of the information described herein, which is necessary to carry out the methods and processes of embodiments of the present invention.

Such methods and processes of the present invention, as described herein, may be performed (at least partly) by the processing element 20 of the device 10 executing the computer program stored on the memory element 22.

Device 10 in some examples might be a bicycle computer, portable navigation device, wearable device such as a smartwatch, an augmented display, a smartphone, a portable electronic device, an audio player, combinations thereof, and the like.

In addition to the above-described data, the memory element 22 may be configured to store cartography data and/or climb data. As used herein, “cartography data” means data representative of one or more of the following features within a geographical area, which can be used by the processor 20 to generate a graphical map via the graphic display 26: topography, transportation lines (e.g., paved roads, non-paved roads (e.g., gravel roads, trails, paths, and the like, railroad lines, rivers, streams, etc.), political boundaries, place names, bodies of water, etc. The cartography data may also include location information for each of such features. Such location information may comprise location coordinates, such as latitude and longitude or the like. As a result, the device 12 may be configured to present the cartography data graphically on the graphic display 26, such as in the form of a map as shown in FIG. 1.

As used herein, “climb data” means data representative of various climb characteristics for a section of a transportation line (e.g., a road or trail). Generally, such a section of a road or a trail includes a climb, which as described previously refers to a portion of a road or trail in which altitude is gained. In certain embodiments, a portion of a road or trail may only be defined as a climb if the portion has a minimum length (e.g., at least 500 meters) and such portion exceeds a minimum average gradient (e.g., at least a 3% grade). Regardless, in some embodiments, the climb data may comprise one or more of the following for each climb: length of the climb, grade of the climb, category rating of the climb and/or of the grade, elevation change of the climb, popularity of the climb, specific grade at a given location of the climb, and specific elevation at a given location of the climb. In some embodiments, some or all of the climb data may also be categorized as cartography data. Climb data may also be configurable by the user.

Returning to the components of the portable electronic device 10, the location- determining element 24 may comprise a Global Positioning System (GPS) receiver configured to receive and/or process signals received from GPS satellites. As such, the location-determining element 24 is operable to determine a geographic position of the device 10 through processing of the received signal data. The signals from the GPS satellites may include various data suitable for use in position determination, such as timing signals, ranging signals, ephemerides, almanacs, and so forth. However, it should be apparent that a wide variety of other positioning systems may also be employed, such as other global navigation satellite systems (GNSS), terrestrial based systems (e.g., wireless-phone based systems that broadcast position data from cellular towers), wireless networks that transmit positioning signals, and so on. Furthermore, location-determining element 24 may alternatively, or additionally, include one or more sensors (e.g., gyros, odometers, accelerometers, and/or magnetometers), that aid in generating the position and/or direction of travel of the portable electronic device 10.

As noted above, and as will be described in more detail below, the device 10 is configured to graphically present the cartography data and/or the climb data via the graphic display 26. As such, the graphic display 26 may comprise any device configured to present data in a graphical format, such as an LCD (Liquid Crystal Diode) display, a TFT (Thin Film Transistor)

LCD display, an LEP (Light Emitting Polymer) or PLED (Polymer Light Emitting Diode) display, and/or the like, which are configured to display text and/or graphical information to a user, such as in the form of a graphical user interface (GUI). The graphic display 26 may be backlit via a backlight such that it may be viewed in the dark or other low-light environments. In some embodiments, the graphic display 26 may be configured as a touchscreen to receive input (e.g., data, commands, etc.) from a user. For example, a user may operate the portable electronic device 10 by touching the touchscreen and/or by performing gestures on the touchscreen. In some embodiments, the touchscreen may be a capacitive touchscreen, a resistive touchscreen, an infrared touchscreen, combinations thereof, and the like. In alternative embodiments, or in addition, the portable electronic device 10 may also include the one or more user controls 28, which may comprise input/output (I/O) components, such as a keypad, buttons, a wireless input device, a thumbwheel input device, a trackstick input device, and the like. The user controls 28 may also include one or more audio I/O devices, such as a microphone, speakers, and the like.

Furthermore, the portable electronic device 10 may also include a communication element 30 configured to permit the device 10 to send/receive data between different devices (e.g., components/peripherals) and/or over one or more communications networks. The communication element 30 may include various communication components and functionality including, but not limited to: one or more antennas; a transmitter, receiver, and/or transceiver; a wireless radio; data ports; software interfaces and drivers; networking interfaces; data processing components; and so forth. The networks over which the communication element 30 may communicate include various wired and wireless networks, such as a local area network, a wide area network, an intranet, the Internet; a satellite network; a cellular network; a mobile data network; and the like. Specific examples wireless networks include, but are not limited to: networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

In view of the climb prediction system described above, the portable electronic device 10 is configured to automatically identify one or more routes (e.g., biking-capable roads, trails, paths, or the like) over which a user may ride a bicycle and to present climb data related to such routes. Specifically, the portable electronic device 10 is configured to perform the step of determining, via the location-determining element 24, a location of the device 10. An additional step includes determining, based on the location of the device 10 and the cartography data and/or the climb data stored in the memory elements 22, a predicted route along which the user is predicted to ride the bicycle. An additional step includes presenting, via the graphic display 26, information indicative of the predicted route. An additional step includes determining, based on the cartography data and/or the climb data, one or more optional routes located adjacent to the predicted route along which the user can optionally ride the bicycle. A further step includes presenting, via the graphic display 26, climb data associated with the optional routes.

Broadly, the portable electronic device 10 is configured to present, via the graphic display 26, a graphical map of the geographic area around which the user is performing a cycling event. For example, FIG. 1 illustrates the device 10 attached to the handlebar of the bicycle 12 in such a manner that the user can view the graphic display 26 while the user is riding the bicycle. The graphic display 26 presents a map of the geographic area around which the user is riding the bicycle. Such a map may include graphical representations of various cartography data stored in the memory element 22, such as topography, transportation lines (e.g., paved roads, unpaved roads, trails/paths), bodies of water, and the like. In addition, the device 10 can present the current location of the user and/or the device 10 by obtaining such position via the location-determining element 24, and generating an icon at the appropriate location on the map presented via the graphic display 26. As a result, the user can be provided with up to date information related to the user's current location and the geographic area around the user. Furthermore, as noted above and as discussed in more detail below, the device 10 is configured to predict a route over which the user will likely travel during a cycling event. The device 10 can utilize user preferences, such as a desire for paved over unpaved roads, gravel over dirt, etc., in predicting and suggesting routes for the user.

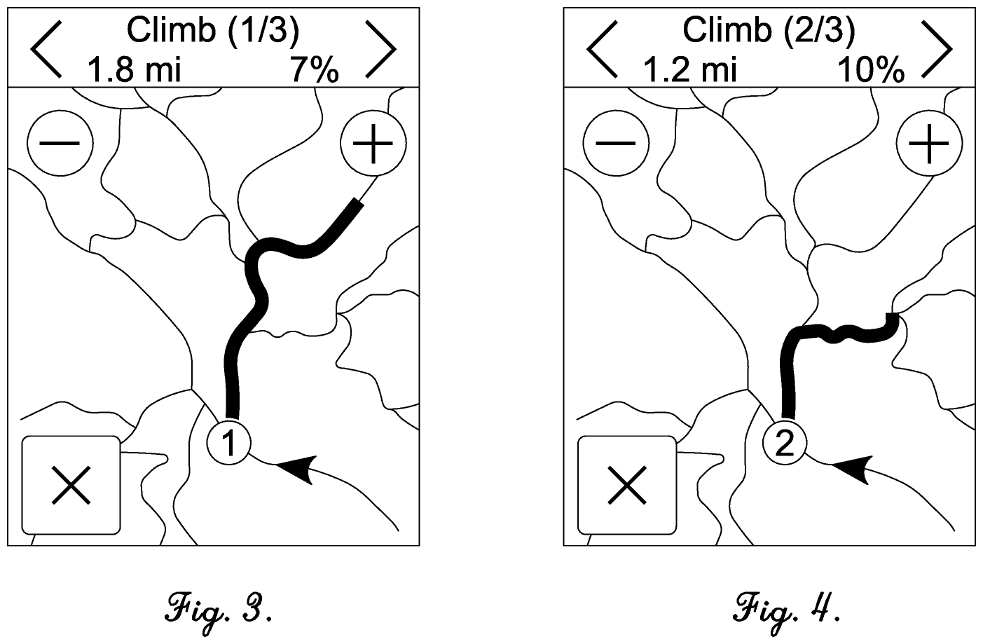

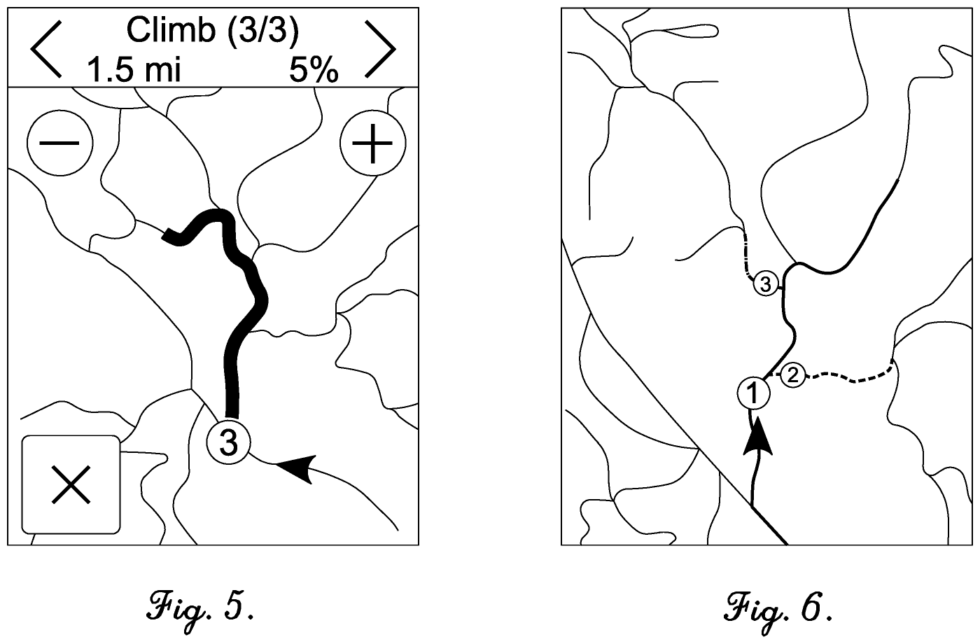

In more detail, FIGS. 3-5 each illustrate a GUI that may be presented on the graphic display 26 of the portable electronic device 10. The GUIs each show individual routes (i.e., routes 1, 2, and 3, respectively) that a user riding a bicycle may travel on during a cycling event. Such routes may each comprise one or more climbs. Notably, the device 10 may be configured to predict one of the routes that the user will likely choose to travel. Such a prediction may be made by obtaining the location of the device 10 (and thus the location of the user and/or the bicycle) via the location-determining element 24. The location of the device 10 may then be compared with the cartography data and/or the climb data to determine a predicted, primary route along which the user may travel with the bicycle. Speed, heading, attitude, and other positional information may also be utilized to help predict the route. Additionally, the device 10 may include a database of past routes cycled by the user or other users, along with associated positional information to help predict the route of the cyclist. The database may be stored locally on device 10 and/or be accessed by device 10 from a remote server using communication element 30.

The predicted, primary route may, in some embodiments, be the closest road or path to the current location of the device 10, such as may be determined by comparing the location of the device 10 with location information associated of nearby transportation lines (e.g., roads or trails) included within the cartography data. In other embodiments, the predicted, primary route may be selected from one or more roads or paths within a particular distance from the current location of the device 10. Such particular distance may, in some embodiments, be identified as preference info (discussed in more detail below) that is provided to the device 10 by the user. Furthermore, various combinations of cartography data may be used by the device 10 to determine the predicted, primary route. For example, the device 10 may determine (e.g., based on preference info inputted by the user requiring that any predicted route should be a paved road) that the predicted, primary route is the paved road that is closest to the location of the device 10. Or, alternatively, the device 10 may determine (e.g., based on preference info inputted by the user requiring that any predicted route should be an unpaved or gravel trail or path) that the predicted, primary route is the unpaved or gravel trail or path that is closest to the location of the device 10.

In additional embodiments, the predicted, primary route may be determined by the device 10 by comparing a direction of travel of the device 10 with the cartography data and/or the climb data to determine a predicted, primary route along which the user may travel with the bicycle. Such a direction of travel may be determined by the location-determining element 24 determining a location of the device 10 at a first point in time and at a second point in time. The device 10 may, therefore, be configured to determine a direction of travel of the device 10 (and thus the direction of travel of the user and/or the bicycle) as being the direction of positional change by the device 10 between the first and second points in time. Alternatively, the accelerometer of the location-determining element 24 may be used to determine a direction of travel of the device 10. Regardless, embodiments may, in some embodiments, be configured to determine a predicted, primary route by comparing a direction of travel of the device 10 with the cartography data and/or the climb data, such as by identifying the nearest paved road, which is also in the direction of travel of the device 10.

Alternatively, or in addition, when determining the predicted, primary route, the device 10 may also analyze climb data for analyzing potential predicted, primary routes. For example, the user may enter preference info into the device 10 (e.g., via the touchscreen and/or the user controls 28), with such preference info being stored within the memory element 22. The preference info may establish criteria that routes must satisfy to be identified by the device 10 as a predicted, primary route. For example, the user may identify, via entry of the preference info, that the user only wishes to travel over routes that have one or more climbs (i.e., a portion of a route that satisfies the minimum length and minimum gradient requirements). For example, the device 10 may determine the predicted, primary route as the route closest to the location of the device 10 that has at least one climb. Alternatively, or in addition, the user may identify, via entry of the preference info, that the user only wishes to travel over routes that have one or more climbs that satisfy: a minimum/maximum length, a minimum/maximum grade, a minimum/maximum/specific rating and/or grade, a minimum/maximum elevation change, a minimum/maximum number of climbs, and/or a particular popularity level. For example, out of the potential routes illustrated in FIGS. 3-5 (which are each in close proximity to the user), the device 10 may select the most popular route as the predicted route. Such popularity may be determined as the route that other users commonly travel during other cycling event (with such information being stored in the memory element 22). Regardless, it should be understood that the device 10 may use any combination described above of location of the device 10, direction of travel of the device 10, cartography data, and/or climb data to determine a predicted route.

Alternatively, or in addition, other climb data may be used by the device 10 to determine the predicted, primary route. For example, the user may indicate (e.g., via entered preference info) that the user only wishes to travel on routes that are close in proximity and that are greater than 1.5 miles in length. With respect to FIGS. 3-5, the device 10 can analyze the climb data for each of routes 1, 2, and 3, and determine that only route 1 (i.e., from FIG. 3) satisfies this distance requirement. Specifically, as illustrated in the figures, route 1 is 1.8 miles, whereas routes 2 and 3 are 1.2 miles and 1.5 miles, respectively. Thus, the device may select route 1 as the predicted, primary route.

Alternatively, or in addition, the user may indicate (e.g., via entered preference info) that the user only wishes to travel on routes that are close in proximity and that include climbs that satisfy a particular difficulty level, gradient value, and/or category rating. In more detail, embodiments of the present invention may be configured to rate climbs based on average gradient, length, and/or combinations of the above. For example, climbs with an average gradient: between 0 and 3% may be rated as category 4; between 3 and 6% may be rated as category 3; between 6 and 9% may be rated as category 2; and between 9 and 12% may be rated as category 1. In view of such category ratings, the user may indicate (e.g., via entered climb characteristics) that the user only wishes to travel on routes that are close in proximity and that have a rating of a category 2 climb. The device 10 can, thus, analyze the climb data for each of routes 1, 2, and 3, and determine that only route 1 (i.e., from FIG. 3) satisfies this category rating requirement. Specifically, as illustrated in the figures, route 1 has an average gradient of 7% (i.e., category 2), whereas routes 2 and 3 have average gradients of 10% (i.e., category 1) and 5% (i.e., category 3), respectively. Thus, the device may select route 1 as the predicted, primary route.

It should be understood that the above examples are provided for purposes of illustration, and the device 10 may be configured to analyze any of the cartography data and/or the climb data when determining a predicted, primary route a user will likely take during a cycling event. Nevertheless, the device 10 is configured to determine, via the location-determining element 24, a location of the device 10 (as the user is riding a bicycle with the device 10 attached thereto).

And based on the location of the device 10 and any of the cartography data and/or the climb data, the device 10 is further configured to determine a predicted, predicted route along which the user is predicted to ride the bicycle. As will be described in more detail below, the device 10 is configured to present to the user, via the graphic display 26 as the user is performing a cycling event, various types of climb data associated with the predicted, primary route. Furthermore, as discussed more below, the device 10 is also configured to provide information to the user as to one or more optional routes over which the user may travel, as well as climb data associated with such optional routes.

In more detail, and turning to FIG. 6, the illustrated GUI (which may be presented on the graphic display 26 of the device 10) presents a graphical map of a user riding a bicycle through a geographic area during a cycling event. The portable electronic device 10 may obtain the location of the device 10 (and thus the bicycle and the user) via the location-determining element 24, and may generate a location icon (i.e., the black arrow of FIG. 6), which is overlaid onto the map to illustrate the current location of the user. In addition, the device 10 may determine a predicted, primary route over which the user may travel during the cycling event, as was described previously (e.g., based on the location of the device 10 and the cartography data and/or climb data). For purposes of illustration, route 1 from FIG. 6 has been determined by the device 10 as the predicted, primary route. The predicted, primary route may be highlighted (e.g., the road or trail of the predicted, primary route may be highlighted with bolding or with a particular color or cross hatching) so that the user can easily identify the predicted, primary route. In addition, various types of climb data associated with the predicted, primary route may be presented to the user, as discussed in more detail below. Furthermore, the device 10 may be configured to determine one or more optional routes over which the user may choose to travel during the cycling event. The device 10 may present such optional routes, as well as various climb data associated with such optional routes, to the user, via the graphic display 26, as the user performs the cycling event.

In more detail, and remaining with FIG. 6, the device 10 has identified route 2 and route 3 as optional routes that the user may take during the cycling event. Such optional routes may be determined by the device 10 analyzing the cartography data to identify routes (e.g., roads, trails, or paths) that are adjacent to (e.g., within a specified distance) or that connect with the predicted route. As illustrated, both routes 2 and 3 of FIG. 6 connect with the primary, predicted route 1. Other cartography data may also be used to determine optional routes. For example, the device 10 may determine (e.g., based on preference info inputted by the user) that optional routes should only include those routes that are comprised of paved roads and that are in close proximity to the location of the device 10. Or, alternatively, the device 10 may determine (e.g., based on preference info inputted by the user) that optional routes are only those routes that are comprised of gravel trails or paths that are in close proximity to the location of the device 10.

In some embodiments, the device 10 may also analyze the climb data associated with potential optional routes before selecting such optional routes for presentation to the user. For example, the user may enter preference info specifying that the user only wishes to be presented with optional routes that have one or more climbs that satisfy: a minimum/maximum length, a minimum/maximum grade, a minimum/maximum/specific category rating and/or grade, a minimum/maximum elevation change, a minimum/maximum number of climbs, and/or a particular popularity level. Regardless, it should be understood that the device 10 may use any combination described above, including location of the device 10, direction of travel and/or speed of the device 10, cartography data, and/or climb data to determine optional routes. Thus, optional routes may be identified in the same or similar manner as the predicted routes.

For purposes of illustration, the user may provide preference info indicating that the user only wishes to be presented with optional routes that have climb category ratings of 2 or 3. With respect to FIG. 6, the routes 2 and 3 are assumed to have a climb rating of 2 and 3, respectively. As such, after identifying route 1 as the predicted, primary route, as shown in FIG.

6, the device 10 may further identify routes 2 and 3 as optional routes because (1) routes 2 and 3 each intersect with the predicted, primary route 1, and (2) routes 2 and 3 each satisfy the climb category rating required by the user (i.e., route 2 has a climb category rating of 2 and route 3 has a climb category rating of 3). After determining the predicted, primary route 1 and the optional routes 2 and 3, the device 10 may present a GUI (as in FIG. 6) in the form a geographical map of the area around the device 10, as well as the routes 1, 2, 3. Notably, the predicted, primary route 1 may be highlighted (e.g., with bolding or with a particular color or cross hatching) to indicate that route 1 is the predicted route. In addition, optional routes 2 and 3 may be highlighted (e.g., with bolding or with a particular color or cross hatching) to indicate that routes 2 and 3 are optional routes.

In some embodiments, the optional routes may also be highlighted with a particular coloring or cross-hatching (or other indicia) that is indicative of specific climb data associated with such routes. For example, category 4 climbs may be colored “green”; category 3 climbs may be colored “yellow”; category 2 climbs may be colored “orange”; and category 1 climbs may be colored “red.” In view of such highlighting, the device 10 may be configured to present, as illustrated by the GUI of FIG. 6, a geographical map around the location of the device 10. In addition, the GUI can present to the user the predicted, primary route and the optional routes determined by the device 10. Furthermore, the GUI can present various climb data associated with such predicted, primary route and/or optional routes. For example, as illustrated in FIG. 6, the optional routes may be highlighted with the particular colors that indicate the climb rating associated with such routes. For purposes of illustration, the different broken line types shown in FIG. 6 are used place of different coloring; however, it is understood that optional route 2 may be highlighted with the color orange (indicating a category 2 climb) and optional route 3 may be highlighted with the color yellow (indicating a category 3 climb). Although the above illustrates how the optional routes may be highlighted to indicate climb data in the form of climb category ratings, it should be understood that routes may, in other embodiments, be highlighted to indicate various other types of climb data. Different line styles (dotted, dashed, textured, etc.), thicknesses, and the like may additionally or alternatively be used to highlight the optional routes.

In view of the GUI presented to the user in FIG. 6, the user can perform the cycling event by riding over the predicted, primary route 1 and/or optionally over the optional routes 2 and/or 3. Notably, the device 10 will continually determine, via the location-determining element 24, the location of the device 10 (and thus the user and/or the bicycle), such that the device 10 can continuously determine the particular route over which the user is currently traveling. In some embodiments, the device 10 will determine that the route over which the user is currently travelling will be the predicted, primary route. However, the user can also manually select one of the routes to be the predicted, primary route by interacting with the GUI presented on the graphic display 26 (e.g., via the user controls 28 and/or by touching the touchscreen of the graphic display 26). For example, if the user manually selects one of the optional routes 2 and 3 via interaction with the graphic display 26, and the device 10 will automatically change the optional route that was selected by the user to be a new primary, predicted route.

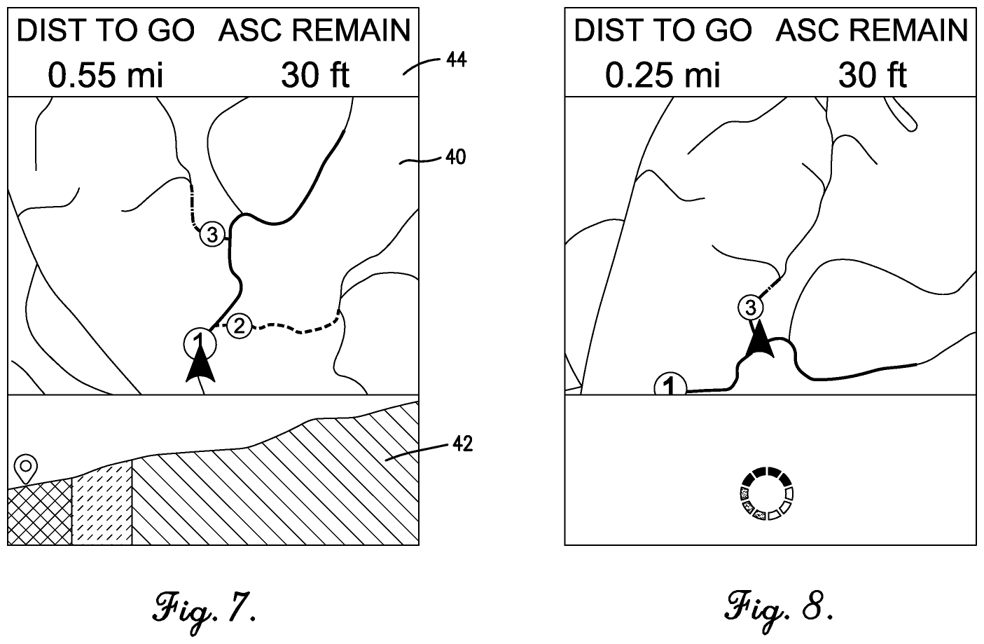

Nevertheless, if the user begins traveling on the predicted route 1, as shown in the GUI of FIG. 7, the device 10 may present a split screen showing various cartography data and/or climb data to the user as the user performs the cycling event. For example, a first portion 40 of the split screen may present a map of the geographic area around the device 10 (and thus around the user and the bicycle). Such map will include illustrations of the predicted, primary route and any of the optional routes identified by the device 10. Such routes, as discussed above may be highlighted with different colors (or other indicia) to easily identify the routes and/or to indicate various climb data associated with such routes (as discussed previously). The map may also include an icon (e.g., the black arrow) that indicates the real-time position of the device 10.

A second portion 42 of the split screen may be configured to present climb data associated with the climb being performed by the user as the user travels over the predicted, primary route 1. As shown in FIG. 7, the second portion 42 may be positioned below the first portion 40 and may present a cross-sectional representation of the climb of route 1 being performed by the user. Specifically, the cross-sectional representation illustrates the change in elevation throughout the climb, from start to finish. Furthermore, the device's 10 current position (and thus the position of the user and the bicycle) is shown on top of the cross-sectional representation (in the form of a balloon icon), so as to indicate the amount of the climb the user has already completed, as well the amount of the climb that remains for the user to complete. It is noted that the icons representing the position of the device 10 (and thus the user and the bicycle) are updated in real-time on the portions 40 and 42 of the split screen, as the device 10 travels over the route. Furthermore still, the body area of the cross-sectional representation of the climb shown in the second portion 42 may be highlighted with different colors (illustrated in FIG. 7 by the different cross-hatching) that each illustrate the average gradient for different sections of the climb.

In addition, the GUIs presented by the device 10, via the graphic display 26, may present various other types of information to the user via other portions of the split screen. For example, a third portion 44 may present other climb data to the user, such as the remaining distance the user has to travel over the current route or climb, e.g., route 1. The third portion 44 may also present the remaining change in elevation the user has to travel over the current route and/or climb. Nevertheless, various other climb data may be presented to the user during the cycling event. In addition, the device 10 may be configured to generate user ride statistics and present such ride statistics via the GUI displayed on the graphic display 26. Such ride statistics may comprise: time spent on climb, total elevation change during climb, total distance travelled during climb, current speed, calories burned, 3-second average power, and the like. Thus, ride statistics broadly comprise information related to the activities that the user has performed or completed during performance of a cycling event.

As discussed above, once the user begins travelling over the predicted, primary route (i.e., route 1 from FIGS. 6 and 7), the device 10 is configured to present to the user a split screen showing a map (with the predicted route and any optional routes), as well as various climb data associated with the route over which the user is travelling (i.e., route 1 from FIG. 7). However, the optional routes (i.e., routes 2 and 3) will still be presented, along with climb data associated with such optional routes, while the user is traveling over the predicted, primary route. The user may manually select any of the optional routes, such as by touching the graphical representations of such routes on the displayed map, at which time the selected optional route will be identified as the new primary, predicted route, and climb data associated with such new route can be displayed to the user as the user travels over the newly selected optional route (which is then updated to be considered the primary, predicted route). Alternatively, the device 10 may automatically determine that one of the optional routes should be identified as the primary, predicted route should the user start to travel on the optional route.

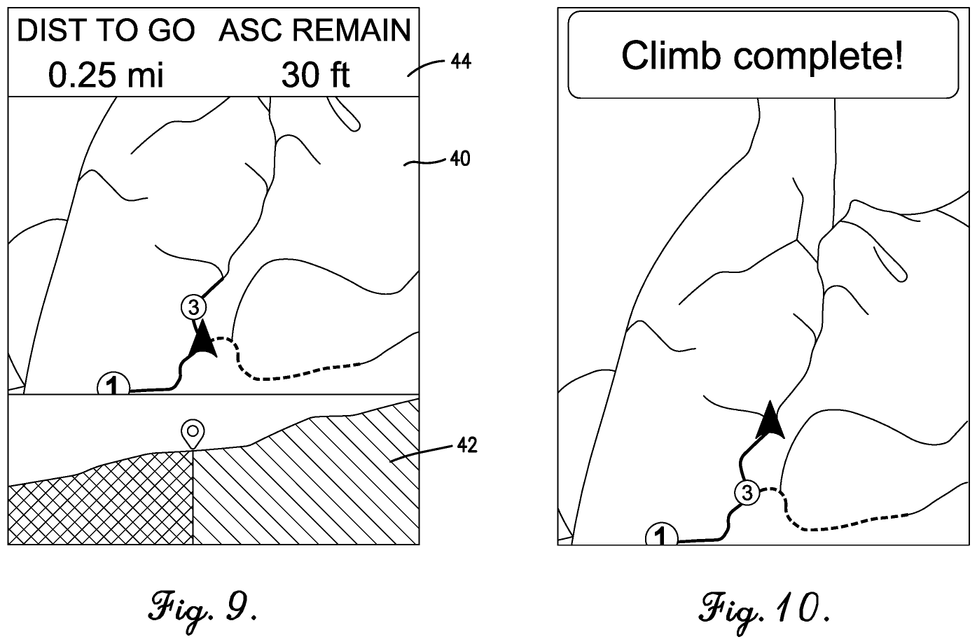

For example, as shown in FIG. 8, the device 10 may determine, via comparing the device's 10 real-time position (and thus the position of the user and the bicycle) as obtained from the location-determining element 24 with the cartography data, that the user has transitioned from travelling over the precited route (i.e., route 1) to one of the optional routes (i.e., route 3). At such time, the device 10 may change the predicted route from route 1 to route 3, and the climb data for the route 3 (the optional route that is now determined to be the predicted, primary route) can be presented to the user. Specifically, as shown in FIG. 9, the geographic map from portion 40 of the GUI can be updated with route 3 now shown with the highlighting of the predicted, primary route (e.g., the road or trail of the predicted route may be highlighted with bolding or with a particular color or cross hatching), and route 1 has been transitioned to an optional route, perhaps with associated highlighting for optional routes (e.g., highlighted with coloring indicative of climb category rating). Furthermore, the climb data shown in portions 42 and 44 can also be updated, so as to be associated with route 3, and shown to the user.

Once the user has completed the cycling event, such as by finishing the predicted, primary route including any optional paths that were traversed by the user, the device 10 may present, via the graphic display 26 that the route and/or any climbs associated with such route has been completed. In examples where the cycling event is unplanned or unstructured, such as where no defined route or activity has been set by the user, the device 10 may record the traversed routes and associated climbs for later analysis by the user. Additionally, the device 10, or an associated mobile application or cloud service, may present climb data for climbs actually climbed by the user during the event in combination with climb data for optional climbs that were not traversed—e.g., climbs associated with optional paths that were not followed by the user. In addition, any climb data and/or ride statistics associated with the cycling event may be presented to the user and/or saved in the memory elements 22 for later reference. In some embodiments, the climb data and/or ride statistics may be transmitted, e.g., via the communication element 30, to a remote device (e.g., mobile application associated with a smartphone) or server (e.g., cloud service) for later access and review by the user.

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

Claims:

1. A portable electronic device configured to be used by a user riding a bicycle, said portable electronic device comprising:
one or more memory elements, wherein the memory elements are configured to store cartography data and climb data;
a location-determining element configured to determine a location of said portable electronic device; and
a graphic display configured to present the cartography data and/or the climb data in a graphical format;
wherein said portable electronic device is configured to—
determine, via the location-determining element, a location of said portable electronic device,
determine, based on the location of said portable electronic device and the cartography data and/or the climb data, a predicted route along which the user is predicted to ride the bicycle,
present, via the graphic display, information indicative of the predicted route,
determine, based on the cartography data and/or the climb data, one or more optional routes located adjacent to the predicted route along which the user can optionally ride the bicycle, and
present, via the graphic display, climb data associated with the optional routes.

2. The portable electronic device of claim 1, wherein said portable electronic device includes an attachment assembly configured to releasably attach said portably electronic device to the bicycle.

3. The portable electronic device of claim 1, wherein the location-determining element comprises a GPS receiver.

4. The portable electronic device of claim 1, wherein the cartography data comprises data for one or more of the following features within a geographic area: topography, transportation lines, political boundaries, place names, and bodies of water, and wherein the cartography data includes location information for each feature.

5. The portable electronic device of claim 4, wherein the climb data comprises data associated with a section of a transportation line, wherein the transportation line comprises a road, and wherein the section of the road includes a climb having a minimum change in elevation over at least a portion of a length of the section.

6. The portable electronic device of claim 5, wherein the climb data comprises data for one or more of the following: a length of the climb, a grade of the climb, a category ranking of the climb, and an elevation change of climb.

7. The portable electronic device of claim 5, further configured to display, via the graphic display, ride statistics of the user riding along the climb.

8. The portable electronic device of claim 7, wherein the ride statistics comprise one or more of the following: time spent on the climb, total elevation change during the climb, total distance travelled during the climb, calories burned during the climb, and 3-second average power.

9. The portable electronic device of claim 1, wherein the predicted route is determined by comparing the position of said portable electronic device and the cartography data and/or the climb data.

10. The portable electronic device of claim 1, wherein the predicted route is determined by comparing a direction of travel of said portable electronic device and the cartography data and/or the climb data.

11. The portable electronic device of claim 10, wherein the predicted route is determined by identifying a transportation line comprising a d road closest to the location of said portable electronic device in the direction of travel said portable electronic device.

12. The portable electronic device of claim 10, wherein the predicted route is determined by identifying a transportation line comprising at least one climb closest to the location of said portable electronic device in the direction of travel said portable electronic device.

13. The portable electronic device of claim 10, wherein the predicted route is determined by locating a transportation line comprising at least one climb .

14. The portable electronic device of claim 1, wherein the optional routes are determined by locating transportation lines that connect with the predicted route.

15. The portable electronic device of claim 14, wherein the optional routes are determined by locating transportation lines each comprising at least one climb .

16. The portable electronic device of claim 1, wherein the portable electronic device is configured to display, via the graphic display, a graphical representation of the predicted route and the optional routes on a graphical map.

17. The portable electronic device of claim 16, wherein the predicted route and the optional routes are highlighted portions of transportation lines on the graphical map, wherein the highlighted portions of the transportation lines for the optional routes are displayed in different colors on the graphical map, and wherein the different colors are based on climb data associated with the optional routes.

18. The portable electronic device of claim 16, wherein the portable electronic device is further configured to display, via the graphic display, climb data associated with the predicted route, and wherein the graphical map and the climb data associated with the predicted route are displayed on a split screen of the graphic display, with the graphical map displayed on a first portion of the split screen and the climb data associated with the predicted route displayed on a second portion of the split screen.

19. A portable electronic device configured to be used by a user riding a bicycle, said portable electronic device comprising:
one or more memory elements, wherein the memory elements are configured to store cartography data and climb data;
a location-determining element configured to determine a location of said portable electronic device; and
a graphic display configured to present the cartography data and/or the climb data in a graphical format;
wherein said portable electronic device is configured to—
determine, via the location-determining element, a location of said portable electronic device,
determine, based on the location of said portable electronic device and the cartography data and/or the climb data, a predicted route along which the user is predicted to ride the bicycle,
present, via the graphic display, information indicative of the predicted route,
determine, based on the cartography data and/or the climb data, one or more optional routes located adjacent to the predicted route along which the user can optionally ride the bicycle, and
present, via the graphic display, a graphical representation of the predicted route and the optional routes on a graphical map,
wherein the predicted route and the optional routes are highlighted portions of transportation lines on the graphical map, wherein the highlighted portions of the transportation lines for the optional routes are displayed in different colors on the graphical map, and wherein the different colors are based on climb data associated with the optional routes.

20. The portable electronic device of claim 19, wherein the optional routes are determined by locating transportation lines each comprising at least one climb s.
